(19) United States
(12) Patent Application Publication
(10) Pub. No.: US 2017/0275427 A1
(43) Pub. Date: Sep. 28, 2017

(54) PROCESS FOR PRODUCING A COMPOSITE ARTICLE

(71) Applicant: Dow Global Technologies LLC, Midland, MI (US)

(72) Inventors: Asjad Shafi, Lake Jackson, TX (US); Krishnan Karunakaran, Lake Jackson, TX (US); Kamesh R. Vyakaranam, Missouri City, TX (US)

(21) Appl. No.: 15/505,661

(22) PCT Filed: Nov. 24, 2015
(86) PCT No.: PCT/US2015/062438

§ 371 Date: Feb. 22, 2017

Related U.S. Application Data
(60) Provisional application No. 62/091,885, filed on Dec. 15, 2014.

(51) Int. Cl. C08J 5/04; B29D 23/00; B29C 53/58; C08J 3/24

(52) U.S. Cl. CPC C08J 5/04; C08J 3/243; B29D 23/001; B29C 53/58; C08J 2363/10; B29C 2035/0827

(57) ABSTRACT

A multistage filament winding process for manufacturing a composite article using a dual chemistry formulation including the steps of (a) providing a dual chemistry formulation containing components to effectuate dual cure of the formulation; (b) winding fibers on a liner or on a mandrel; (c) impregnating the wound fibers of step (b) with the dual chemistry formulation; (d) activating a first reaction (A) by UV or thermal-free radical initiation sufficient to form first macroscopic gels and to allow the first macroscopic gels to phase separate from the remaining substantially unreacted components in the formulation; (e) optionally, activating a second reaction by heating through IR lamps or other heating apparatus and controlling the second reaction sufficient to form second macroscopic gels subsequent to the formation of the first macroscopic gels which have gelled and phase separated in the formulation; (f) repeating steps (a)-(d) until a composite article having a predetermined thickness is formed; and (g) heating the formed composite article of step (f) sufficient to form a final composite article product having a predetermined glass transition temperature; a cured thermoset article prepared by the above process; and a process for manufacturing spoolable pipe.

### FIELD

The present invention is related to a process for preparing a thermoset composite article via a filament winding process utilizing a dual chemistry formulation. The dual chemistry formulation is useful, for example, in a process for manufacturing a composite article such as a spoolable pipe via a filament winding process.

### BACKGROUND

Epoxy resins are a class of thermosetting resins known to be useful for various applications including composites, coatings, adhesives, films, and electrical laminates. The epoxy resins are typically used with a reinforcing substrate such as glass fibers and the combination is usually cured with hardeners or curing agents. When cured, the resultant epoxy resin thermosets are known for exhibiting good thermal resistance, chemical resistance, and mechanical properties. However, controlling and balancing the different properties of a cured thermoset such that the thermoset can be useful in certain applications is still difficult to achieve in view of a number of different competing factors influencing the final properties of a final curable epoxy resin composition. For example, by increasing the thermal resistance such as Tg of a thermoset, some mechanical properties of the thermoset such as elongation at break and toughness may suffer. On the other hand, by increasing the mechanical properties of the thermoset such as elongation at break and toughness, the Tg may suffer. It is always a challenge in the field to develop epoxy resins offering improved properties that can be used in a wide variety of applications.

As an illustration, one of the mechanical properties required for a cured epoxy resin thermoset to be suitable and useful in certain applications, such as for manufacturing spoolable pipe, is “high elongation”, that is, as the pipe is spooled, the top of the pipe must stretch and the bottom of the pipe must compress; and the pipe should be able to elongate and compress without developing any permanent change in shape or damage. A curable resin composition that, upon curing, provides a thermoset composite article exhibiting high elongation while still maintaining its Tg is advantageous in the manufacture spoolable composite pipe because known filament winding processes require epoxy resin formulations to undergo multiple winding and resin impregnation stages; and thermoset composites exhibiting high elongation are suitable for such application.

U.S. Provisional Patent Application Ser. No. 61/917,482 entitled “Curable Compositions”, filed by Karunakaran et al., on Dec. 18, 2013 (U.S. 61/917,482), incorporated herein by reference, discloses a curable resin system that can be used in a filament winding process. U.S. 61/917,482 discloses a process for processing formulations in such a way that causes olefinic monomer reactions before epoxy amine reactions; and phase separation to provide high elongation for the same Tg compared to non-phase separated formulations. However, U.S. 61/917,482 does not disclose the use of its curable resin system formulations for manufacturing spoolable pipes or how to generate the phenomenon of immediate increase in viscosity in combination with the phase separation to impart improved properties to spoolable pipe. Furthermore, U.S. 61/917,482 does not teach how to make thick spoolable pipe using multi-stage winding stations and multi-stage ultraviolet light (UV) curing stations. Thus, the process of U.S. 61/917,482 is limited by the penetration of UV during UV curing.

It would be desirable to provide a suitable curable epoxy resin system that can be cured to form a thermoset having improved properties such as an improved elongation property while maintaining the same heat resistance property of the product when compared to known analogs of such epoxy resin products. And, it would be desirable to provide a suitable curable epoxy resin system that can be used in a continuous filament winding process that includes multiple resin impregnation stages, multiple fiber winding stages, and multiple UV curing stages to make a thermoset product such as a spoolable composite pipe.

### SUMMARY

One embodiment of the present invention is directed to a multistage filament winding process for manufacturing a composite article from a dual chemistry formulation comprising the steps of:
(a) providing a dual chemistry formulation including the following components:
   (i) at least one epoxy resin;
   (ii) at least one thermally reacting hardener;
   (iii) a polyol with free radical active functional groups;
   (iv) at least one radiation or thermal reactive initiator; and
   (vi) optionally, at least one monomeric acrylate or monomeric methacrylate;
   wherein the dual chemistry formulation is adapted to react under reaction conditions to effectuate the following:
      (A) a first reaction via a free radical chain growth mechanism to form first macroscopic gels which phase separate out from the remaining components of the dual chemistry formulation sufficient to provide a viscosity increase due to gellation and to provide a toughening increase; and
      (B) a second reaction via a step growth mechanism; wherein the reactivity of the second reaction is controlled to form second macroscopic gels subsequent to the formation of the first macroscopic gels which have gelled and phase separated;
(b) winding fibers on a liner or on a mandrel;
(c) impregnating the wound fibers of step (b) with the dual chemistry formulation;
(d) activating the first reaction (A) by UV or thermal-free radical initiation sufficient to form first macroscopic gels and to allow the first macroscopic gels to phase separate from the remaining substantially unreacted components in the formulation;
(e) optionally, activating the second reaction by heating through IR lamps or other heating apparatus and controlling the second reaction sufficient to form second macroscopic gels subsequent to the formation of the first macroscopic gels which have gelled and phase separated in the formulation;
(f) repeating steps (a)-(d) until a composite article having a predetermined thickness is formed; and
(g) heating the formed composite article of step (f) sufficient to form a final composite article product having a predetermined glass transition temperature and/or other beneficial properties.

In another embodiment of the present invention, the multistage filament winding process includes the step of repeating steps steps (a)-(d) for a predetermined number of times until the UV curing of the curable resin system is substantially complete to form a composite article with multiple layers of UV cured resin; and then, thermally curing the composite article to provide a cured thermoset composite article.

In still another embodiment of the present invention, the above described continuous multistage filament winding process can be used to produce a spoolable pipe.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a schematic block flow diagram showing a multistage winding UV curing and thermal curing process for making a spoolable pipe article.

### DETAILED DESCRIPTION

A “multiple cure system, formulation or composition” herein, with reference to a composition, means a curable composition that, upon mixing the components of the curable composition, the composition is capable of being cured via two or more different mechanisms or reactions.

An example of a multiple cure system is a “dual cure system” or a “dual chemistry formulation”. A “dual cure system” or a “dual chemistry formulation” herein, with reference to a resin composition, means at least two stages of curing of a resin composition including: (1) a free radical curing stage such as a radiation curing stage as a first stage and (2) a thermal curing stage such as an epoxy-curing agent condensation curing as a second stage.

In one embodiment, the duel cure system of the present invention includes at least two different and separate types of chemical reactions that occur as the curing process of the present invention curable composition proceeds. For example, the dual cure system of the present invention includes at least: (1) the free radical polymerization of a methacrylated or acrylated polyol using radiation curing such as UV light from a UV light source; and (2) the curing reaction between an epoxy compound and a curing agent (e.g., an epoxy resin-curing agent condensation reaction). In the present invention, the methacrylated or acrylated polyol cures first via free radical polymerization before the epoxy-curing agent thermoset reaction takes place. In the present invention process, the polymerized methacrylated or acrylated polyol forms a network of its own and undergoes phase separation during the epoxy-curing agent thermoset network formation.

By “immediate increase in viscosity” herein, with reference to a resin composition or formulation, it is meant that the resin formulation undergoes a change in viscosity during the first stage of curing, i.e., the UV stage within a period of time of about 0.1 second to about 60 seconds wherein the delta change in viscosity is an increase of at least 25% from the initial viscosity of the resin. The immediate increase in viscosity property of a curable composition can be measured using, for example, the method described in ASTM D455.

“Phase separation” or “phase separating” herein, with reference to a curable composition, refers to the action of the curable composition forming a distinct secondary phase wherein the dimensions of the secondary phase can be in the range of nanometer to micrometer range, and wherein the dimensions can be measured by various analytical techniques such as by scanning electron microscopy (SEM) and transmission electron microscopy (TEM).

By “high elongation property” of an epoxy thermoset it is meant that when the dual cure curable epoxy resin composition is cured, the resultant cured thermoset beneficially exhibits an elongation property of greater than or equal to (≧) about 5%. The elongation property of a cured thermoset can be measured using, for example, the method described in ASTM D-638.

By “liner-free” with reference to a pipe member herein means a filament-wound pipe that does not require a liner, and is made entirely of filament-wound thermosetting resin. The conventional production process for flexible pipes makes use of a thermoplastic liner onto which fibres are applied with a rotating mandrel or a thermoplastic liner as the basis for the mandrel (winding).

The filament winding process of the present invention may be used to manufacture a variety of cured thermoset products including for example prepregs, laminates, composites, pressure vessels, wind blades, and the like, and coatings. In one preferred embodiment, the filament winding process is used to produce a cured thermoset article such as a spoolable pipe article.

For example, to start the multistage filament winding process of the present invention, the following is first provided: (i) a liner-free mandrel or a liner member; (ii) a winding apparatus; (iii) a reinforcement material; (iv) a dual cure curable resin system having a UV activated resin portion and a thermally reactive resin portion; and (v) a resin impregnating means for impregnating the reinforcement material with the dual cure curable resin system.

In one broad embodiment, the multistage filament winding process for manufacturing a composite article from a dual chemistry formulation includes the following steps:
(a) providing a dual chemistry formulation including the following components:
   (i) at least one epoxy resin;
   (ii) at least one thermally reacting hardener;
   (iii) a methacrylated or acrylated polyol;
   (iv) at least one radiation reactive initiator;
   (v) optionally, at least one thermally activated free radical initiator; and
   (vi) optionally, at least one monomeric acrylate or monomeric methacrylate;
   wherein the dual chemistry formulation is adapted to react under reaction conditions to effectuate the following:
      (A) a first reaction via a free radical chain growth mechanism to form first macroscopic gels which phase separate out from the remaining components of the dual chemistry formulation sufficient to provide a viscosity increase due to gellation and to provide a toughening increase; and
      (B) a second reaction via a step growth mechanism; wherein the reactivity of the second reaction is controlled to form second macroscopic gels subsequent to the formation of the first macroscopic gels which have gelled and phase separated;
(b) winding fibers on a liner or on a mandrel;
(c) impregnating the fibers with the dual chemistry formulation;
(d) activating the first reaction through UV or thermal free radical initiation sufficient to form first macroscopic gels and to allow the first macroscopic gels to phase separate from the remaining substantially unreacted components;
(e) optionally, activating the second reaction by heating through IR lamps or other heating apparatus and controlling the second reaction sufficient to form second macroscopic gels subsequent to the formation of the first macroscopic gels which have gelled and phase separated;
(f) repeating steps (a)-(d) until a composite article having a predetermined thickness is formed; and
(g) heating the formed composite article of step (f) sufficient to form a final composite article product having a predetermined glass transition temperature.

The dual cure curable resin system used to impregnate the reinforcement material contains a free radical reactive resin portion and a thermally reactive resin portion. For example, the dual cure curable resin system includes: (a) at least one epoxy resin; (b) at least one thermally reacting hardener; (c) at least one polyol with free radical active end functional groups; (d) at least one radiation or thermal reactive initiator; (e) optionally, at least one thermally activated free radical initiator; and (f) optionally, at least one monomeric acrylate or methacrylate. When thermal reactor initiators are used, the initiator must activate before significant step growth reaction of the epoxy components so that the polymerized polyol can phase separate.

In a multistage filament winding process for manufacturing a cured thermoset article with UV light, such as a spoolable pipe, the process may include a general step of repeating steps (I)-(III) of the process described above. The steps (I)-(III) can be repeated at least one time and preferably two or more times to form a composite article with multiple layers of UV cured resin.

To manufacture a cured spoolable pipe member, for example, step (I) winding a dry reinforcement material about a mandrel which is liner-free or alternatively, about a liner member to form a dry wound reinforcement material; (II) impregnating the dry wound reinforcement material with a dual cure curable resin system to form a resin impregnated reinforcement material about the mandrel; and (III) curing, by UV light, the dual cure curable resin system in the resin impregnated reinforcement material; can be repeated until the UV curing portion of the curable resin system is substantially complete and forms a composite article with a predetermined number of layers and a predetermined thickness, i.e., multiple layers of UV cured resin is formed. One sequence of steps (I) to (III), in that order, of the process is herein considered to be one stage of the multistage filament winding process. Then, at a final stage of the process, the multilayer UV cured resin composite article is heated to thermally cure the composite article to provide a fully cured spoolable pipe member.

At the first stage of the process, the reinforcement material can be dry fibers and the dry fibers are wound on a mandrel and impregnated with the curable resin system; and then, the resin-wetted fibers are UV cured to react the UV active functional group in the resin which leads to phase separation of the UV activated resin from the other thermal resin system. After the initial stage of feeding dry fibers to the resin impregnating means and UV curing the fibers to partially cure the resin, a partially UV cured resin/fiber composite on a mandrel is passed through subsequent UV curing stages of the process. Phase separation provides a unique set of properties to the curable resin system including an immediate increase in viscosity wherein immediate increase in viscosity is a property required by the composition before the next stage of winding and impregnation. The phase separation provides the benefit(s) of providing a composite with a high elongation property for use in various applications such as spoolable pipe. After the UV curing (the first curing mechanism of the above dual cure resin system), the UV cured composite can be optionally passed through a thermal curing stage where the second curing mechanism further increases the viscosity. However, thermal curing should be limited. If the second chemistry components gel, further winding of the fibers may not allow optimal packing of fibers. After the last set of winding, impregnating and uv curing stages, the composite is subsequently passed through a thermal curing stage (the second curing mechanism of the above dual cure resin system) to thermally cure the UV cured composite to provide a cured composite article product such as a spoolable pipe member. In one embodiment, the thermal cure step can be carried out at least one or more times.

In general, one embodiment of the process of manufacturing a spoolable pipe using a multistage continuous filament winding process may include, as a first step (I), winding dry reinforcement material such as dry fibers about a mandrel or a liner to form a dry wound reinforcement material on the surface of the mandrel or the liner. A suitable mold release may be needed when winding fibers directly on the mandrel. The mandrel can be with or without a pressure barrier layer or a liner material; or, alternatively, a self-supporting liner can be used to wind dry fibers thereon without the use of a mandrel. By “self-supporting” with reference to a liner, it is meant that the liner develops green strength before a next layer of fibers are wound on the liner. The liner can be used with or made with the same thermosetting resin that is used to impregnate the fibers; and/or the liner can be made separately off the production line or made directly on the production line.

In yet another embodiment, the process may include winding dry fibers onto a partially wound and impregnated pipe member.

The winding apparatus and mandrel can be any conventional filament winding means which is used to wind impregnated reinforcement material about a mandrel such that a composite article can be formed. The winding apparatus and mandrel is described with reference to the drawings herein below.

The reinforcement material used in the filament winding process includes fibers or filaments or fiber strands or tows. “Filament” or “monofilament” as used herein is intended to mean the smallest increment of fiber. The terms “strand”, “tow” or “bundle” as used herein, is intended to mean a plurality of individual fibers ranging from, but not limited to, dozens to thousands in number, collected, compacted, compressed or bound together by means known to the skilled person in order to maximize the content thereof or to facilitate the manufacturing, handling, transportation, storage or further processing thereof. “Tape” is typically a material constructed of interlaced or unidirectional filament, strands, tows, or yarns, etc., usually pre-impregnated with resin.

The continuous fibers that may be employed in accordance with the present invention to reinforce the thermosetting resin matrix; and the fibers can be organic, synthetic, natural, mineral, glass, ceramic, metallic or mixture thereof. The fibers may be in any form and combination, such as a plurality of filaments, strands, non-woven veil, continuous filament mat, chopped strand mat, fabric, strong enough and having sufficient integrity and strength to be pulled through the impregnating substance such as molten thermoplastic polymer, and that may conveniently consist of bundles of individual filaments, referred to in the art as “strand”, in which substantially all of the filaments are aligned along the length of the bundles. Preferably, the fibers are in a strand form, made up of continuous filaments. Any number of such strands may be employed. Suitable materials include strands and tapes of glass fiber, mineral, ceramic, metallic, carbon, graphite fiber, synthetic, polymeric fibers or natural fibers or mixtures and blends of them. In the case of commercially available glass ravings, each strand may consist of one or several smaller strands with altogether up to about 6,000 or more continuous glass filaments. Carbon fiber containing up to about 50,000 or more filaments may be used.

Synthetic fibers that may be utilized within the scope of the present invention include polyolefin, aramid fibers, polyester, polyamide, polyimide fibers, acrylic fibers, vinyl fibers, benzoxazole based fibers, cellulose and cellulose derivative based fibers, carbon, graphite fibers, polyphenylene sulfide fibers, ceramic fibers. Continuous fibers may be provided with any of the conventional surface sizing, particularly those designed to facilitate storage and transport before processing and improve usability. Additionally, other coatings may be included on the fibers, particularly glass fibers, in order to protect the fiber from abrasion and improve the characteristics of a final composite part.

Step (II) of the present invention process includes impregnating the dry wound reinforcement material about the mandrel from step (I) with an impregnation substance. The impregnation substance used for injecting into or impregnating the reinforcing material can be a system, composition, or formulation. In a preferred embodiment of the present invention for example, a dual cure curable resin system is impregnated into the reinforcement material or fibers as the fibers contact the resin impregnating resin system to form a resin impregnated reinforcement material about the mandrel.

In one embodiment, the reinforcement material such as fibers can be impregnated with a dual cure curable resin system which advantageously contains a radiation reactive resin portion and a thermally reactive resin portion. For example, the dual cure curable resin system includes: (a) at least one epoxy resin; (b) at least one thermally reacting hardener; (c) at least one methacrylated or acrylated polyol; (d) at least one radiation reactive initiator; (e) optionally, at least one monomeric acrylate or at least one monomeric methacrylate; and (f) optionally, at least one thermally activated free radical initiator.

In a preferred embodiment, the resin system can include for example one or more epoxy resins, one or more amine hardener, methacrylate or vinyl terminated polyol, hydrocarbons, or polyester, which phase separates after exposure to UV light, and are swelled by the epoxy formulations resulting in formation of wet gels with significant viscosity increase, or UV radical initiators suitable for a given UV lamp.

In another embodiment, the curable resin system that can be used in the present invention may also include the curable resin described in U.S. Provisional Patent Application Ser. No. 61/917,482 entitled “Curable Compositions”, filed by Karunakaran et al., on Dec. 18, 2013, incorporated herein by reference. The above patent application discloses a process for processing formulations in such a way that causes olefinic monomer reactions before epoxy amine reactions; and phase separation to provide high elongation for the same Tg compared to non-phase separated formulations. However, above patent application does not disclose the use of formulations in spoolable pipes or how to generate the phenomenon of immediate increase in viscosity in combination with phase separation particularly for spoolable pipe applications. Furthermore, the above patent application does not teach how to make thick spoolable pipe in multi-stage winding and UV curing stations; and thus, the process described in the above patent application will be limited by the penetration of UV. The above patent application teaches that the free radical reaction, and hence the phase separation, should take place before the other reaction is significantly advanced.

The present invention provides use of UV to initiate free radical reaction as the first reaction process of the present invention. UV curing is carried out in different stages/layers of the process, i.e., free radical reaction for the whole composite article takes place in stages and at the end of all of the UV stages, the first UV reaction is complete. The final thermal cure (the second reaction) takes place at the end of all of the UV stages. The final thermal cure can be carried out to substantially complete the second reaction.

In the present invention, the impregnation resin system is preferably a thermosetting resin. The thermosetting resin may include curable epoxy resin systems that are commonly used to reinforce fibers and then cured to provide a composite article useful in the composite industry. Examples of the thermosetting polymer resin may include, but are not limited to, those resins based on epoxy, novolacs, phenolics, polyesters, vinyl ester resins, polyurethanes, and mixtures thereof.

In one preferred embodiment, the thermosetting material may be an epoxy resin. For example, in preparing the curable resin formulation of the present invention, at least one epoxy or polyepoxide compound starting material, component (a), can be used. The epoxy resins useful in the present invention may be selected from any known epoxy resin in the art; and may include conventional and commercially available epoxy resins, which may be used alone or in combinations of two or more. For example, an extensive enumeration of epoxy resins useful in the curable resin composition of the present invention includes epoxides described in Pham et al., Epoxy Resins in the Kirk-Othmer Encyclopedia of Chemical Technology; John Wiley & Sons, Inc.: online Dec. 4, 2004 and in the references therein; in Lee, H. and Neville, K., Handbook of Epoxy Resins, McGraw-Hill Book Company, New York, 1967, Chapter 2, pages 2-1 to 2-27, and in the references therein; May, C. A. Ed. Epoxy Resins: Chemistry and Technology, Marcel Dekker Inc., New York, 1988 and in the references therein; and in U.S. Pat. No. 3,117,099; all which are incorporated herein by reference.

In selecting epoxy resins for the compositions disclosed herein, consideration should not only be given to properties of the final product, but also to viscosity and other properties that may influence the processing of the resin composition. In one embodiment, particularly suitable epoxy resins useful in the present invention are based on reaction products of polyfunctional alcohols, polyglycols, phenols, cycloaliphatic carboxylic acids, aromatic amines, or aminophenols with epichlorohydrin. Other suitable epoxy resins useful for the compositions disclosed herein include reaction products of epichlorohydrin with o-cresol and epichlorohydrin with phenol novolacs. In another embodiment, the epoxy resin useful in the present invention for the preparation of the epoxy resin composition may be selected from commercially available products, such as for example, D.E.R.® 330, D.E.R. 331, D.E.R. 332, D.E.R. 324, D.E.R. 352, D.E.R. 354, D.E.R. 383, D.E.R. 542, D.E.R. 560, D.E.N.® 425, D.E.N. 431, D.E.N. 438, D.E.R. 542, D.E.R. 560, D.E.R. 736, D.E.R. 732 or mixtures thereof. D.E.R resins are commercially available from The Dow Chemical Company.

In another embodiment, the curable composition of the present invention may include at least one low viscosity epoxy resin compound as component (a) to form the epoxy matrix in a final curable formulation. For example, the low viscosity liquid epoxy resin compound useful in the present invention may include the epoxy compounds described in U.S. Pat. No. 8,497,387; U.S. Provisional Patent Application Ser.

No. 61/660,403, filed Jun. 15, 2012, by Maurice Marks; and U.S. Provisional Patent Application Ser. No. 61/718,752, filed Oct. 26, 2012, by Stephanie Potisek et al., all of which are incorporated herein by reference.

A few non-limiting embodiments of the epoxy resin useful as a compound in the curable epoxy resin formulation of the present invention may include, for example, epoxies selected from the group consisting of bisphenol-A based epoxy resins, bisphenol-F based epoxy resins, resorcinol based epoxy resins, methylolated phenol based epoxy resins, brominated and fluorinated epoxy resins, and combinations thereof.

Examples of preferred embodiments for the epoxy resin include bisphenol A diglycidyl ether, tetrabromobisphenol A diglycidyl ether, bisphenol F diglycidyl ether, resorcinol diglycidyl ether, triglycidyl ethers of para-aminophenols, epoxy novolacs, divinylarene dioxides, cycloaliphatic epoxy, and mixtures thereof.

Generally, the amount of epoxy resin compound used in the present invention must be of a sufficient amount to provide from about 0.9 to about 1.5 epoxy groups for every active hydrogen in the hardener and that the thermally curing system (epoxy, hardener, catalyst for epoxy reactions) should make more than 50% of the total formulation, but less than 97%. The free radical chemistry components should make up from about 3% to about 50% of the total formulation. The amount epoxy discussed above should be enough to ensure that phase separation occurs in the curable resin composition.

The at least one thermally reacting hardener compound (also referred to as a “curing agent” or a “crosslinking agent”) useful for the curable resin formulation of the present invention can be any conventional hardener compound known to be suitable for curing an epoxy resin-based formulation. The curing agent for the above epoxy resin may include for example, one or more curing agents selected from the group consisting of amines (including aliphatic, cycloaliphatic, aromatic, dicyandiamide), polyamides, polyamidoamines, phenol- and amine-formaldehyde resins, carboxylic acid functional polyesters, anhydrides, polysulfides and polymercaptans; and mixtures thereof.

In one preferred embodiment, the hardener compound useful for the present invention may include diethylenetriamine, isophoronediamine N-aminoethylpiperazine diethyl toluene diamine, diethylene toluene diamine or mixtures thereof.

Generally, the amount of hardener useful in the present invention, may be for example, from 0.5 equivalents (molecular weight/functionality) to about 1.2 equivalents for every equivalent of epoxy in one embodiment, from about 0.75 equivalents to about 1.15 equivalents for every equivalent of epoxy in another embodiment; from about 0.85 equivalents to about 1.1 equivalents for every equivalent of epoxy in still another embodiment; and from about 0.95 equivalents to about 1.05 equivalents for every equivalent of epoxy in yet another embodiment. The functionality of an epoxy containing compound is defined as number of epoxy groups per molecule and the functionality of a hardener is defined as the number of epoxy groups that a hard molecule can react with.

The above described combination of (a) at least one epoxy resin; and (b) at least one thermally reacting hardener forms the thermally reactive portion of the dual cure curable resin system which advantageously contains a radiation reactive resin portion and a thermally reactive resin portion.

The methacrylated or acrylated polyol compound useful for the curable resin formulation of the present invention may include for example at least one polyol capped with methacrylate or acrylate groups (i.e., “methacrylated or acrylated polyols”). In one particular preferred embodiment, the methacrylated polyol compound may include the compound having the following chemical structure of structure (I) where n can be from 3 to 10:

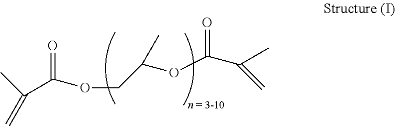

For example, the above compound can be polypropylene glycol dimethacrylate (e.g., SR 644 from Sartomer where n=4, BLEMMER PDP 400 where n is 7).

In another particular preferred embodiment, the methacrylated polyol compound may include the compound having the following chemical structure of structure (II) where n can be from 2 to 14:

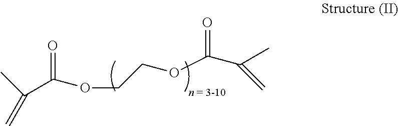

For example, the above compound can be polyethylene glycol dimethacrylate (e.g., SR 603 from Sartomer where n=9, BLEMMER PDE 100, 150, 200, 400, and 600 where n are 2, 3, 4, 9, and 14, respectively).

Generally, the amount of methacrylated polyol useful in the present invention, may be for example, from 5 wt % to about 40 wt % in one embodiment, from about 8 wt % to about 35 wt % in another embodiment; from about 11 wt % to about

30 wt % in still another embodiment; and from about 12 wt % to about 20 wt % in yet another embodiment, based on the total weight of the composition.

The methacrylated polyol should be within the above ranges in the formulation system sufficient to get a network. At concentrations lower than 5 wt %, the cured thermoset does not show high elongation. At concentrations higher than 40 wt %, the mechanical properties of the curable formulation start to drop.

The at least one radiation reactive initiator compound useful for the curable resin formulation of the present invention may include, for example a UV initiator. The UV initiator compound useful for the curable resin formulation of the present invention can be any conventional UV initiator compound useful for initiating UV curing the resin formulation. For example, the UV initiator compound of the present invention may include phosphine oxides, bis phosphine oxides, or mixtures thereof. The phosphine oxides and bis phosphine oxides are preferred due to their sensitivity to higher wavelengths Amino ketone can also be used, especially if optional thermal free radical initiators are being used. In addition, the UV initiator compound may include for example α-hydroxyketones such as Irgacure® 184 (1-hydroxy-cyclohexyl-phenyl-ketone).

In one preferred embodiment, the phosphine oxide UV initiator of the present invention may include for example Irgacure® 819 from BASF—bis(2,4,6-trimethylbenzoyl)-phenylphosphineoxide having the following structural chemical formula:

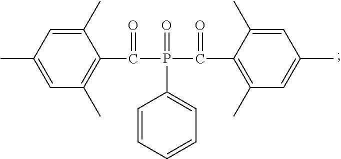

2,4,6-trimethylbenzoyl-diphenyl phosphinate having the following structural chemical formula:

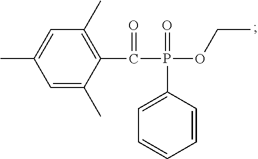 [SMILES: CCOP(=O)(C(=O)c1c(C)cc(C)cc1C)c1ccccc1]

Irgacure® 907 2-methyl-1 [4-(methylthio)phenyl]-2-morpholinopropan-1-one having the following structural chemical formula:

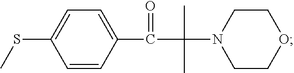 [SMILES: CSc1ccc(C(=O)C(C)(C)N2CCOCC2)cc1]

or
mixtures thereof.

Generally, the amount of UV initiator compound useful in the present invention, may be for example, from 0.1 wt % to about 4 wt % in one embodiment, from about 0.4 wt % to about 3 wt % in another embodiment; from about 0.7 wt % to about

2.0 wt % in still another embodiment; and from about 1.0 wt % to about 1.5 wt % in yet another embodiment, based on the total weight of the composition.

The above described combination of (c) at least one methacrylated or acrylated polyol compound; and (d) at least one radiation reactive initiator compound forms the radiation reactive resin portion of the dual cure curable resin system which advantageously contains a radiation reactive resin portion and a thermally reactive resin portion.

Optionally, other useful compounds can be added to the resin system and may include for example one or more thermally activated free radical initiators.

The optional thermal free radical initiator compound useful for the curable resin formulation of the present invention can be any conventional thermal free radical initiator compound useful for the resin formulation, for example peroxides such as diisobutyryl peroxide, dibenzoyl peroxide, azo compounds such as—azodi(isobutyronitrile), or any other appropriate thermal free radical initiator.

Generally, the amount of thermal free radical initiator, when used in the present invention, may be for example, from 0 wt % to about 4 wt % in one embodiment, from about 0.01 wt % to about 3.5 wt % in another embodiment; from about 0.1 wt % to about 3 wt % in still another embodiment; and from about 0.5 wt % to about 1 wt % in yet another embodiment, based on the total weight of the composition.

Another useful optional compound that can be added to the resin system may include for example one or more monomeric acrylates/methacrylates. The optional monomeric acrylate/methacrylate compound useful for the curable resin formulation of the present invention can be any conventional monomeric acrylate/methacrylate compound useful for improving the viscosity build.

In one embodiment, the monomeric acrylate/methacrylate compound useful for the present invention may include, for example, cyclohexyl acrylate/methacrylate, lauryl acrylate/methacrylate, glycidal acrylate/methacrylate, tetra propyl acrylate/methacrylate, and mixtures thereof.

Generally, the amount of monomeric acrylate/methacrylate compound, when used in the present invention, may be for example, from 0 wt % to about 20 wt % in one embodiment, from 0 wt % to about 15 wt % in another embodiment; from 0 wt % to about 10 wt % in still another embodiment; and from 0 wt % to about 5 wt % in yet another embodiment, based on the total weight of the composition.

Various other optional component(s), compound(s) or additive(s) useful for their indented purpose and well known by those skilled in the art may be added to the impregnating resin formulation, in accordance with the processing and end use of the composite structure reinforced with long fibers, and conditions under which the composite structure is used. For example, such additives may include catalysts, reactive and non-reactive diluents, epoxy molecules completely or partly reacted to terminate with methacrylate or vinyl group, other hardeners such as phenolic hardeners, other methacrylates which form networks by itself as well as phase separate during the epoxy-hardener curing, other free radical initiators, fillers, dyes, pigments, colorants, thixotropic agents, surfactants, fluidity control agents, stabilizers, diluents, adhesion promoters, flexibilizers, toughening agents, fire retardants, antioxidants, mold releasing agents, impregnation accelerators, impact modifiers, viscosity reducers, lubricants, compatibilizers, coupling agents, wetting and leveling agents, and mixtures thereof.

Any of the optional compounds described above may be added to the curable composition so long as the optional compounds described above do not deleteriously affect the UV free radical initiator curing reaction or the thermal curing reaction processes of the present invention.

Generally, the amount of the optional additive(s), when used in the present invention, may be for example, from 0 wt % to about 7 wt % in one embodiment, from

0 wt % to about 5 wt % in another embodiment; and from 0 wt % to about 2 wt % in still another embodiment; based on the total weight of the composition.

The process for preparing the curable resin composition or formulation of the present invention includes admixing (a) at least one epoxy resin; (b) at least one thermally reacting hardener; (c) a methacrylated polyol or acrylated polyol; and (d) at least one radiation reactive initiator such as a UV initiator. Other optional additives such as a catalyst or a thermal free radical initiator can be mixed with the above components to form the curable formulation.

For example, the preparation of the curable resin formulation of the present invention is achieved by blending, in known mixing equipment, the epoxy resin the thermally reacting hardener; the methacrylated polyol; and the UV initiator, and optionally any other desirable additive or ingredient as desired and described above. Any of the above-mentioned optional additives, for example a curing catalyst, may be added to the composition during the mixing or prior to the mixing to form the formulation.

All the compounds of the curable formulation are typically mixed and dispersed at a temperature enabling the preparation of an effective curable epoxy resin formulation having the desired balance of properties for a particular application. For example, the temperature during the mixing of all components may be generally from about −10° C. to about 40° C. in one embodiment, and from about 0° C. to about 30° C. in another embodiment. Lower mixing temperatures help to minimize reaction of the epoxide and hardener in the composition to maximize the pot life of the composition.

The preparation of the curable formulation of the present invention, and/or any of the steps thereof, may be a batch or a continuous process. The mixing equipment used in the process may be any vessel and ancillary equipment well known to those skilled in the art.

Generally, the viscosity of the liquid impregnating curable resin formulation should be sufficient to flow into and through the reinforcement material, i.e., to flow and impregnate the reinforcing material and attach to the reinforcing material, and to prevent substantial loss of resin by dripping out. The viscosity of the liquid impregnating resin can be adjusted by controlling the temperature of the resin, up to just below the degradation temperatures of the impregnating resin, in order to have the optimum melt viscosity for the impregnation.

One of the benefits of the curable composition described above and useful in the process of the present invention is that the resin advantageously exhibits several useful properties such as for example an “immediate increase in viscosity”. In the curable resin system of the present invention, the free radical polymerization under UV exposure occurs to provide a network swollen by unreacted epoxy resin-hardener blend which results in an instant viscosity increase. The instant viscosity increase property of the curable resin is an advantageous property for the curable resin to be useful, for example, in a filament winding process because the instant viscosity increase property allows for winding of a next layer of fibers while squeezing out excess resin.

Initially, the resin composition or formulation of the present invention has an initial viscosity of, for example, less than or equal to (≦) about 1,500 mPa-s at 25° C. Generally, the initial viscosity of curable formulation can be from about 100 mPa-s to about 10,000 mPa-s in one embodiment, from about 200 mPa-s to about 5,000 mPa-s in another embodiment, and from about 500 mPa-s to about 2,000 mPa-s in still another embodiment at 25° C.

After subjecting the curable composition to UV light, the resin formulation undergoes an increase in viscosity of 10,000 mPa-s and the viscosity before the resin formulation is thermally cured can be for example from about 5,000 mPa-s to about 1,000,000 mPa-s in one embodiment, from about 10,000 mPa-s to about 700,000 mPa-s in another embodiment, and from about 50,000 mPa-s to about 500,000 mPa-s in still another embodiment at 25° C.

In addition, the curable resin of the present invention exhibits a “phase separation” property which, when the curable resin is cured, provides a toughening property to the cured thermoset without reducing the Tg of the main phase. Thus, in the application related to spoolable pipe, the spoolable pipe prepared from the above curable resin system is suitable for high temperature (e.g., greater than 100° C.) applications.

The curable formulation, when cured, endows the cured thermosets such as spoolable pipe made from the curable formulation with excellent flexibility, impact resistance, chemical resistance and other properties such as glass transition, fatigue life which can be attributable to the curable ester resin composition of the present invention.

Because the curable epoxy resin composition advantageously exhibits a low initial viscosity, and then the composition has an increase in viscosity property, the composition is suitable for processes wherein a low viscosity curable composition is needed for ease of processing the composition through the operation. For example, processes for preparing composites using a filament winding process. And, because the curable composition exhibits a combination and balance of properties, including phase separation and an immediate increase in viscosity, the curable epoxy resin composition of the present invention can be advantageously useful in a filament winding process for making spoolable pipe.

The resin impregnating means useful in the present invention can be any conventional resin impregnating means known in the art such as for example a vessel adapted for mixing the above described curable resin formulation components and for injecting the mixed resin into the fibers wound on the mandrel. Alternately, an inline mixing system can be used to mix the different components immediately before the resin impregnating system. The resin impregnating means typically has an inlet for receiving curable resin and an optional outlet discharging the impregnation resin therefrom and injecting the impregnation resin into the reinforcement material disposed on the mandrel of a winding apparatus and thereafter passing the impregnated reinforcement material about the mandrel to a curing station so as to form a partially cured composite layer on the mandrel.

In general, the curing of the dual cure curable composition used in the process of the present invention involves a first and a second curing reaction of the curable composition including a combination of free radical polymerization curing in the first curing reaction and thermal condensation curing in the second curing reaction. For example, a free radical initiator is present in the curable composition to promote free radical polymerization of the methacrylated or acrylated polyol in the first curing reaction by subjecting the curable composition to UV exposure. In the second curing reaction, a condensation of the epoxy resin and curing occur by thermal curing methods.

Generally, the process for curing the dual curable composition via a combination of UV exposure and thermal curing, respectively, may be carried out at a predetermined temperature and for a predetermined period of time for the UV conditions sufficient to cure the methacrylated or acrylated polyol via the first curing reaction in the composition; and at a predetermined temperature and for a predetermined period of time for the thermal conditions sufficient to cure the epoxy via the second epoxy-curing agent reaction in the composition.

Step (III) of the present invention process includes curing the dual cure curable resin system which has been impregnated into the reinforcement material preferably by exposing the impregnated fibers to any conventional radiation light source such as UV light as the first curing reaction of the curable composition. Exposing the wet or impregnated fibers to UV radiation advantageously allows the olefinic bonds present in the formulation react with each other and then the reaction phase separates to form a UV reacted portion in the composite layer and an unreacted thermal portion in the composite layer. The phase separation property is important because this provides a dual cure mechanism for the curable composition.

The process conditions for the UV free radical polymerization of the methacrylated or acrylated polyol in the first curing reaction includes for example using a UV light at a wavelength of from about 100 nanometers to about 450 nanometer in one embodiment, from about 100 nanometers to about 400 nanometer in another embodiment, from about 200 nanometers to about 450 nanometers in still another embodiment, from about 200 nanometers to about 350 nanometers in yet another embodiment, from about 280 nanometers to about 450 nanometers in even still another embodiment, and from about 280 nanometers to about 350 nanometers in even yet another embodiment. The curable composition can be contacted with UV light at a temperature of for example from about 0° C. to about 100° C.; and for a time of for example from about 0.1 minute to about 60 minutes.

Optionally, olefinic bonds can be cured with thermal initiators of free radicals instead free radicals initiated by UV. In such case, the free radial initiator should activate at temperatures significantly lower than the curing temperature for the epoxy reactions.

Step (IV) of the process of the present invention includes thermally curing the composite article. The composite is made up of multiple layers of a combination of reinforcement material about the mandrel and/or liner and resin impregnated into the reinforcement material which has been partially cured on the mandrel by UV light in Step (III). The composite is thermally cured to form a substantially completely cured wound thermoset article.

Once the desired thickness of a composite article, such as the thickness of the pipe wall of a spoolable pipe, is reached, Step (IV) of the process is carried out which includes heating the composite to a temperature sufficient to substantially cure the composite to substantial completion. For example, the curing of the total curable resin composite should be carried out to at least greater than 70 percent in one embodiment, greater than 80 percent in another embodiment, and greater than 90 percent in still another embodiment. The thermal cure involves the reaction between the epoxy resin and the amine hardener present in the dual curable composition.

In one embodiment, the spoolable pipe may be heated at a predetermined temperature and for a predetermined period of time sufficient to thermally cure the formulation. The thermal curing may be dependent on the hardener used in the formulation or other optional additives included in the formulation. However, adjustments to the formulation can be made by one skilled in art depending on the desired enduse product such as spoolable pipe to be manufactured. In one embodiment, for example, the temperature of heating the pipe to thermally cure the pipe may be generally from about 100° C. to about 200° C.; from about 120° C. to about 180° C. in another embodiment; and from about 150° C. to about 180° C. in still another embodiment. Below a temperature of about 100, the temperature may be too low to ensure sufficient reaction under conventional processing conditions; and above about 200, the temperature may be too high to be practical or economical. Also, if the temperature is above 200, the high temperature may cause degradation of the formulation.

Generally, the curing time for the process of thermal curing the curable formulation depends upon the hardener and the catalyst used in the formulation. However, the curing time may be chosen between about 1 minute to about 30 minutes in one embodiment, between about 2 minutes to about 20 minutes in another embodiment, and between about 3 minutes to about 10 minutes in still another embodiment. Below a period of time of about 1 minute, the time may be too short to ensure sufficient reaction under conventional processing conditions; and above about 30 minutes, the time may be too long to be practical or economical.

As an optional embodiment of the present invention, the process can include a step of: repeating steps (I)-(III) until a desired thickness is reached for the final composite article such as a spoolable pipe wall thickness. For example, steps (I)-(III) require UV curing the dual cure curable resin system to form a partially cured member. While the steps can be carried out once, preferably, the steps are carried out at least two or more time to form a composite with predetermined number of cured layers such that the thickness of the overall composite made up of multiple layers is at a predetermined thickness; and a composite article with multiple layers of UV cured resin is formed.

In one embodiment of the present invention process, steps (I)-(III) are repeated two or more times until the desired thickness of layers suitable for a spoolable pipe are reached and a spoolable pipe is formed. Generally, the steps (I)-(III) are carried out at least 2 times, and preferably from 2 times to 6 times; more preferably from 2 times to 5 times, and most preferably from 3 times to 4 times. For example, the fibers are dry wound on a mandrel; are impregnated with the epoxy resin formulation to form wet gels with a significant viscosity increase; and the wet fibers are exposed to UV radiation until the thickness of greater than 1 mm is achieved in one embodiment, from about 1 mm to about 7 mm in another embodiment, and from about 2 mm to about 4 mm in still another embodiment. Then the resultant formed spoolable pipe has a wall thickness sufficient to provide mechanical strength to be useful in high pressure applications.

As described above, the present invention process can include several steps or stages with a number of optional intermediate radiation curing steps until the desired final dimensions of the composite article product are reached. The desired product may then be subjected to a final curing step such as by radiation curing or heat curing.

Because the dual cure curable composition used in the process of the present invention exhibits a combination and balance of properties, when the curable composition is cured, the resulting thermoset product, in turn, exhibits unique and beneficial properties such as processability, Tg, and mechanical performance.

The final cured product or thermoset (i.e., the cross-linked product made from the dual cure curable epoxy resin composition) for example shows several beneficial mechanical and thermal properties including advantageously a high elongation property.

Since a high elongation property is beneficial when manufacturing for example spoolable pipe, as one illustrative example of the present invention, includes a spoolable pipe made by the process of the present invention, wherein the cured spoolable pipe exhibits a combination, i.e., a balance, of advantageous properties for the spoolable pipe to function in an environment where conventional spoolable pipe is used. For example, the spoolable pipe can exhibit the following properties:

For example, the cured spoolable pipe product of the present invention exhibits an elongation at break of generally >about 5% elongation in one embodiment and >about 7% elongation in another embodiment. In still another embodiment, the cured spoolable pipe product of the present invention has an elongation at break of from >about 5% elongation to about 30%, elongation and from >about 10% elongation to about 70% elongation in still another embodiment. The elongation property of the cured spoolable pipe product can be measured, for example, by the method described in ASTM D-638.

The thermoset spoolable pipe also exhibits a strain at break of from about 5% to about 100% in one embodiment, from about 5% to about 80% in another embodiment, and from about 5% to about 40% in still another embodiment.

The thermoset spoolable pipe also exhibits a Tg, as measured by DSC, of from about 30° C. to about 250° C. in one embodiment, from about 50° C. to about 240° C. in another embodiment, and from about 60° C. to about 230° C. in still another embodiment.

In general, the wet continuous filament winding process for manufacturing spoolable composite pipe begins with fiber rovings coming from spools of fibers mounted on a creel. The fibers can include for example glass fibers, carbon fibers, aramid fibers, and the like. The fibers are gathered together and collected through a type of fiber guide (i.e., a “comb”) to form a band of fibers. The band of fibers is pulled through a resin impregnation system to impregnate the fibers (wherein the resin interpenetrates the pulled fiber rovings) with a resin formulation (typically a curable resin and hardener formulation). In the present invention, spoolable composite pipe made using a continuous filament winding process includes multiple resin impregnation and fiber winding stages. Then, the resin impregnated fibers are wound on a rotating mandrel or a self-supporting liner material. Once the winding is complete on the mandrel or liner, the resin impregnated fibers are cured, on the mandrel or liner, through a heating process to form a cured article. After the last stage of the multiple winding/impregnation/cure stages, a resulting spoolable pipe product may be formed.

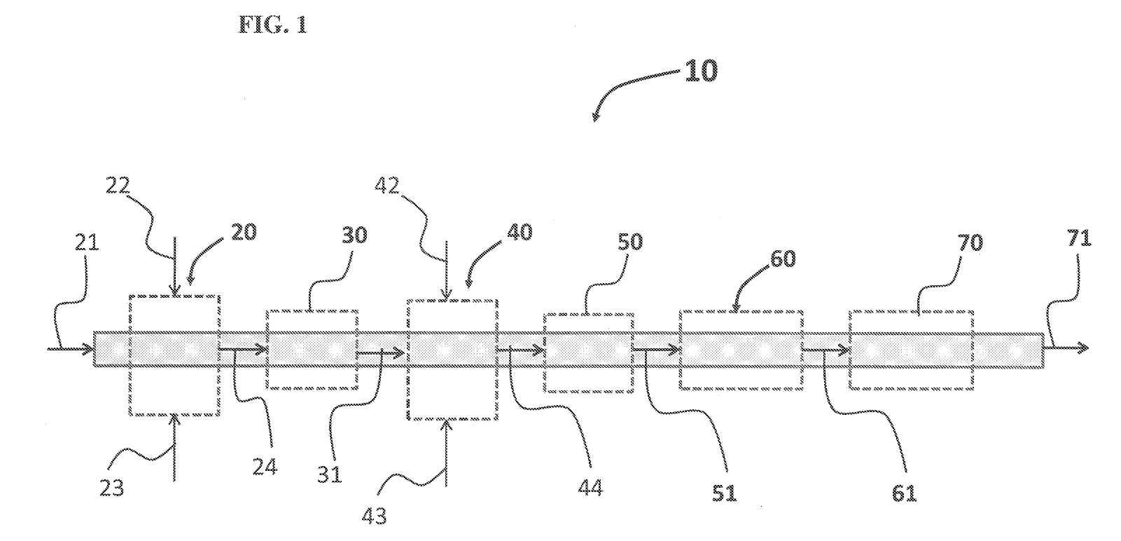

The process of the present invention may be illustrated more specifically with reference to FIG. 1. With reference to FIG. 1, there is shown an overall schematic process flow chart or block flow diagram of the process of the present invention generally indicated by numeral 10. In FIG. 1, there is shown schematically the various pieces of process equipment and apparatus useful for carrying out the process in accordance with one illustrated embodiment of the present invention. In FIG. 1, the process as shown includes several stations or stages including a first impregnation stage, generally indicated by numeral 20; a UV curing process station 30, a second impregnation stage, generally indicated by numeral 40; a second UV curing process station 50; a pulling and thermal curing station, generally indicated by numeral 60; and a product station 70. Although six stations are shown in FIG. 1, the present invention is not limited to such six stations but instead can include any number of stations in any order. The minimum number of stations includes a fiber resin impregnation station 20, a UV curing station 30; and a pulling and thermal curing station 60. Any number of UV curing stations can be used such as two UV curing stations (30 and 50) shown in FIG. 1; or three or more.

Again with reference to FIG. 1, there is shown a mandrel 21 which can be mandrel having a surface free of any materials such as a liner member; or the mandrel 21 can be a liner member. The mandrel 21 can optionally be heated to reduce the viscosity of the curable resin used to impregnate the fibers used in the process and/or to speed up the curing process. In the fiber resin impregnation station 20, a fiber feed 22 is rolled onto the mandrel and a resin feed 23 impregnates the fibers. For example, one or more creels (a bar with skewers for holding bobbins in a spinning machine, not shown) are set up about the mandrel 21 containing a source of continuous filament in the form of rolls of reinforcing dry fiber material 22. The continuous fibers 22 can be a bundle of fibers such as strand or roving. The rolls of fibers 22 are supplied to, and wound onto, the mandrel 21 via a winding means such as fiber rovings on a planetary winder. In the present invention, the dry continuous fibers 22 are directly wound onto the core or mandrel 21 to make a wound dry fiber part or shaped part on the mandrel 21 just prior to the mandrel with the wound dry fibers is impregnated with the resin 23. Any impregnation means known in the art can be used in the present invention including for example a resin impregnation means, a resin injection means, or other conventional fiber wetting system wherein the wound fibers on the mandrel 21 are wetted with a curable resin composition. In one preferred embodiment, the wound dry fiber part or shaped part can be for example a cylindrical shaped article for use in making pipe or a precursor to a container.

In the fiber resin impregnation station 20, the mandrel with the wound fibers part is impregnated with resin with a fiber impregnation or injection means where the impregnation of the fibers with the resin occurs. The direct impregnation of the fibers forms an in-line impregnated continuous fiber reinforced composite structure wherein the composite structure is made up of fibers with resin uniformly dispersed therein 24.

The impregnating resin substance is delivered to the fiber impregnation station 20 via a resin delivery system including stream, mixer, and stream 23. A flow of curable resin composition in resin stream 23 is fed into the mixer means wherein the components of the curable resin are mixed together to form a uniform homogeneous curable formulation. Optionally, the resin components can be premixed in a batch process; and optionally, the resin can be preheated to reduce viscosity and/or speed up curing of the resin. The viscosity of the resin is, for example, generally below about 2,000 mPa-s at the resin injection conditions. The curable formulation from the mixer is then fed to the wound dry fibers on the mandrel via resin stream 23. The resin stream 23 provides a layer of wound continuous fibers on the mandrel wherein the fibers have been wetted and impregnated with the impregnating resin. The wetted fibers on the mandrel then exit the fiber impregnation station 24; and are passed on to the first UV curing stage 30.

In one preferred embodiment, following the impregnation station 20, and more preferably immediately following the impregnation station 20, a curing station 30 is positioned. The curing station 30 is preferably a UV curing station 30.

The impregnating resin substance compositions used in the present invention may be cured upon irradiation, preferably UV radiation, with a wavelength between 100 nm to 450 nm as described above. For example, a long wavelength UV light at 365 nm can be used. By way of example, a suitable UV source is LOCTITE® Zeta® 7200, which contains a 5 inch, 300 Watts/inch medium pressure mercury vapour bulb designed to emit in the UVA and UVB regions. Other equipment may be used. The UV cure may be dependent on UV exposure time and UV intensity which can be determined by one skilled in the art. In a preferred embodiment, the impregnating resin is sufficiently cured within the time to move from the first station to the next winding station. This process, and therefore this requirement, repeats itself for any next applied layer.

UV cure can be sufficient to cure the thermosetting resin system of the present invention. However, in a preferred embodiment as shown in FIG. 1, a final heat cure is applied to the formed pipe article at station 60 to achieve the full strength and required glass transition temperature properties of the final pipe product.

For example, as shown in FIG. 1, the mandrel with the wound continuous fibers impregnated with the impregnating resin 24 passes through at least a first UV curing stage 30 where the wetted fibers are cured with UV radiation light to form a single layer of a partially cured composite part 31 which exits the first UV curing stage 30. In one embodiment, after passing through the first UV curing station 30; and if only a first UV curing stage 30 is desired for a once-through UV curing step, the UV cured composite 31 can pass directly into the thermal heating means 60 and exit the thermal curing stage 60 as a fully cured composite article such as a pipe member on the mandrel 61.

Throughout the above process the fully cured composite article 71 can be continuously pulled through the processing equipment with a conventional pulling mechanism or pulling system 70 located at the end of the process stations. For example, the pulling system 70 may include a pultrusion-like process system. In one embodiment, the thermal heating means 60 can be, for example, a conventional infrared (IR) oven for thermal curing partially UV cured composite. The residence time the partially UV cured composite spends in the IR oven is long enough to reach the green strength of the composite or alternatively to substantially fully cure the composite so that no post curing of the composite product is required.

In another embodiment shown in FIG. 1, at least two UV curing stages 30 and 50, can be used in the process of the present invention. In the process of the present invention, the wound impregnated continuous fiber disposed wound onto the mandrel 21 and exiting the resin impregnation means 20 is an uncured resin wetted composite part or shaped part 24 such as a cylindrical shaped article for use in making pipe or a precursor to a container. The uncured composite shaped part 24 exiting from the resin impregnation means 20 then passes through one or more or any number of impregnation and UV curing stages. In FIG. 1, there is shown a first UV curing stage 30 to form a partially UV cured composite part 31 which can then be passed from the first impregnation and UV curing process station 20 through a second impregnation stage 40 and a second UV curing process station 50; as shown in FIG. 1. Subsequently, the UV cured composite from the second impregnation 40 and second UV curing process station 50 passes through a pulling and thermal curing station 60 as described above.

After the first impregnation and UV curing process station 20 and 30 respectively, the subsequent second impregnation and UV curing process station 40 and 50 respectively; essentially repeat the process steps of the first impregnation and UV curing process station 20 and 30 except that the surface of the mandrel 21 in the first impregnation station 20 prior to the fiber winding stage is free of any fibers, coatings or other materials. The subsequent second impregnation 40 and UV curing process station 50 serve to provide subsequent multiple layers of partially cured composites until a desired thickness of the composite is reached. The thickness of the composite at the end of each process stage, 20, 30, 40, and 50, depends upon the level of UV penetration into the layers. And, the number of stages used in the present invention process may depend upon the total thickness desired for a particular enduse application.

In the embodiment shown in FIG. 1, at least two UV curing process stations, 30 and 50 are used. In one example, after the partially UV cured composite part 31 enters the second fiber winding impregnation station 40 and the second UV curing process station 50, more dry fibers 42 are wound onto the cured composite part 31 to form composite part 44 which is passed through the second UV curing stage 50. The composite part 44 having a layer of resin wetted wound fibers on its surface forms a composite part 44 which is then UV cured in UV curing stage 50. The cured composite 51 exiting the outlet of the curing state 50, is a composite part with two layers of a desired thickness which can then be passed through a pulling and thermal curing station 60 as shown in FIG. 1.

For example, after the partially UV cured composite part 51 having a layer of resin wetted wound fibers on its surface exiting the outlet of the curing state 50, is a composite part with two layers of a desired thickness which can then be passed from the second impregnation and UV curing process station 50 through another impregnation and UV curing process station (not shown) or alternatively, the UV cured composite 51 can be passed from the second impregnation and UV curing process station 50 through a pulling and thermal curing station 60 as shown in FIG. 1.

The pulling and thermal curing station 60 as shown in FIG. 1 includes a thermal curing means (not shown) for heating the UV composite 51 to substantially fully cure the composite using temperature or thermal curing in the heating means. The substantially fully cured composite 61 exiting the heating means 60 is pulled with a pulling means 70. As the substantially completely cured composite 61 is pulled through the pulling means 70, the cured composite can be cut into a desired length composite product (not shown) such as a spoolable pipe product 71.

In one embodiment, the process according to the present invention a filament winding apparatus is used in combination with the pulling means 70 while the composite pipe article is formed in the apparatus shown in FIG. 1. An example of a spoolable pipe article and the techniques of manufacturing such pipe are described in WO97/12166 incorporated herein by reference.

As the pipe article forms in the winding process, the pipe is pulled through the winding stations at the end of the process line. This enables production of variable or even continuous lengths of pipe. In the present invention process reinforcement materials like fibres or woven or braided strands are impregnated with curable thermosetting resin which undergoes polymerization as the resin is subjected to the UV stages and final heating stage.

As aforementioned, the process of the present invention is carried out until the cured composite product has a desired thickness. Generally, for a spoolable pipe product, the thickness may be for example from about 3 mm to about 20 mm in one embodiment, from about 4 mm to about 15 mm in another embodiment, and from about

5 mm to about 10 mm in still another embodiment.

Although now shown, the mandrel in FIG. 1 can include a self supporting liner member. The liner member can be made of, for example polyethylene (PE), polyethylene terephthalate (PET), nylon, any other suitable material, or mixtures thereof. The liner can be sufficiently rigid or self-supporting so as not to require a mandrel as a support means for the liner. In another embodiment, the liner may include a mandrel with the liner on the surface of the mandrel to provide a support means for the liner.

### EXAMPLES

The following examples and comparative examples further illustrate the present invention in detail but are not to be construed to limit the scope thereof.

Various terms and designations used in the following examples are explained and described as follows:

“UV” stands for ultra violet light.

“IPDA” stands for isophorone diamine.

“DMTA” stands for dynamic mechanical thermal analysis.

DER 383 is an epoxy resin compound having an EEW of 176-183 and commercially available from The Dow Chemical Company.

DER 331 is an epoxy resin compound having an EEW of 182-192 and commercially available from The Dow Chemical Company.

PDP 400N is a polypropyleneglycol dimethacrylate compound and commercially available from NOF Corporation.

Irgacure 907 is a 2-methyl-1[4-(methylthio)phenyl]-2-morpholino-propan-1-one compound and commercially available from BASF.

Irgacure 819 is a bis(2,4,6-trimethylbenzoyl)-phenylphosphineoxide compound and commercially available from BASF.

Irgacure TPO-L is a 2,4,6-trimethylbenzoyl-diphenyl phosphinate compound and commercially available from BASF.

The following standard analytical equipment and methods are used in the Examples: The properties of the cured product, including percent elongation, tensile modulus, tensile strength, and strain at break were measured by the method described in ASTM D-638 using Instron equipment. The Tg property of the cured product was measured by the DSC method or the DMTA method on a DSCQ200 TA instrument or an Ares rheometer respectively.

### Example 1

In this example, IPDA (22 g) and DER 383 (100 g) were stirred together and mixed on a Flacktek mixer at 2,000 revolutions per minute (rpm) for 2 minutes (min). Air bubbles were then removed by centrifuging the sample at 2,500 rpm for 3 min.

The mold used in this example was constructed out of two 203.2 mm×203.2 mm (8 inches×8 inches) Pyrex™ plates. A 3.17 mm (0.125 inch) spacer was used to control the thickness of the cured sample. The mixture was poured into the mold using a syringe and the mold was placed in a convection oven. The mold was first heated at

50° C. for 30 min, then at 100° C. for 30 min and finally at 160° C. for 30 min After the mold was taken out of the oven, the mold was allowed to cool to room temperature overnight.

Tensile testing was done according to ASTM D638. The average sample thickness was 3.53 mm (0.139 inch) with a standard deviation (st. dev.) of 0.025 mm (0.001 inch). Elongation at peak load was 3.95% with a st. dev. of 0.170%. DMTA was conducted on an ARES rheometer. The tandelta Tg was 155° C.

### Example 2

In this example, 8.09 g of Irgacure 907 was mixed with 94.1 DER 383. The mixture was mixed on a Flacktek mixer until all of the Irgacure 907 was dissolved. 11.5 g of this solution was mixed with 50 g of DER 383 and 13.3 g of PDP 400N in a Flacktek mixer at 2,000 rpm) for 2 min. Air bubbles were then removed by centrifuging the sample at 2,500 rpm for 3 min.

The mold used in this example was constructed out of two 203.2 mm×203.2 mm (8 inches×8 inches) Pyrex™ plates. A 1.8 mm (0.07 inch) spacer was used to control the thickness of the cured sample. The mixture was poured into the mold using a syringe.

The mold was passed through a Fusion 2000 UV oven, equipped with a Fusion D bulb, at an approximate rate of 6 meters per minute (m/min) (20 feet per minute (ft/min)) for 4 passes. The sample turned white after the 4^{th} pass. The mold was passed through the oven one more time (i.e., a fifth pass). After the UV exposure of the mold, the mold was placed in a convection oven and preheated at 150° C. for 30 min. After the mold was taken out of the oven, the mold was allowed to cool to room temperature overnight.

Tensile testing on the above resultant cured sample was done according to ASTM D638. The average sample thickness was 1.96 mm (0.077 inch) with a st. dev. of 0.1 mm (0.004 inch). Elongation at peak load was 7.73% with a st. dev. of 0.91%. DMTA was conducted on an ARES rheometer. The tandelta Tg was 149° C.

### Example 3

In this example, 100 per billion by weight (pbw) of DER 331 was mixed with 22 pbw of PDP 400N and 0.75 pbw of Irgacure 819. The sample was mixed on a Flacktek mixer until all of the Irgacure 819 was dissolved. 23.0 pbw of IPDA was then added to this mixture and the sample was mixed on a Flacktek mixer at 2,000 rpm for 2 min Air bubbles were then removed by centrifuging the sample at 2,500 rpm for 3 minutes.

The mold was constructed out of two 203.2 mm×203.2 mm (8 inches×8 inches) Pyrex plates. A 3.17 mm (0.125 inch) spacer was used to control the thickness. The sample was poured into the mold using a syringe. The mold was passed through a Fusion 2000 UV oven at approximately 6 m/min (20 ft per min). The oven is equipped with Fusion D bulb. The sample turned whitish after the 2^{nd} pass. The mold was passed through the oven one more time after which it was completely white. After the UV exposure the mold was placed in an oven preheated at 150° C. for 30 min. The mold was then allowed to cool overnight.

Tensile testing of the above mold sample was done according to ASTM D638. The average sample thickness was 3.378 mm (0.133 inch) with a st. dev. of 0.025 mm (0.001 inch). Elongation at peak load was 6.91% with a st. dev. of 1.14%. DMTA was conducted on an ARES rheometer. The tandelta Tg was 143° C.

### Example 4

In this example, 100 pbw of DER 331 was mixed with 22 pbw of PDP 400N and 1.0 pbw of Irgacure TPO-L. 23.0 pbw of IPDA was then added and the sample was mixed on a Flacktek mixer at 2,000 rpm for 2 min Air bubbles were then removed by centrifuging the sample at 2,500 rpm for 3 min. The mold was constructed out of two 203.2 mm×203.2 mm (8 inches×8 inches) Pyrex plates. A 3.17 mm (0.125 inch) spacer was used to control the thickness. The sample was poured into the mold using a syringe. The mold was passed through a Fusion 2000 UV oven at approximately 6 m/min (20 ft/min). The oven is equipped with Fusion D bulb. The sample turned whitish after the 2nd pass. The mold was passed through the oven one more time after which the mold was completely white. After the UV exposure, the mold was placed in an oven which had been preheated at 160° C. for 30 min. The mold was then allowed to cool overnight.

Tensile testing of the above cured sample was done according to ASTM D638. The average sample thickness was 3.429 mm (0.135 inch) with a st. dev. of 0.025 mm (0.001 inch). Elongation at peak load was 7.92% with a st. dev. of 0.752%. DMTA was conducted on an ARES rheometer. The tandelta Tg was 151° C.

1. A multistage filament winding process for manufacturing a composite article from a dual chemistry formulation comprising the steps of:
(a) providing a dual chemistry formulation including the following components:
(i) at least one epoxy resin;
(ii) at least one thermally reacting hardener;
(iii) a polyol with free radical active functional groups;
(iv) at least one radiation or thermal reactive initiator; and
(vi) optionally, at least one monomeric acrylate or monomeric methacrylate;
wherein the dual chemistry formulation is adapted to react under reaction conditions to effectuate the following:
(A) a first reaction via a free radical chain growth mechanism to form first macroscopic gels which phase separate out from the remaining components of the dual chemistry formulation sufficient to provide a viscosity increase due to gellation and to provide a toughening increase; and
(B) a second reaction via a step growth mechanism; wherein the reactivity of the second reaction is controlled to form second macroscopic gels subsequent to the formation of the first macroscopic gels which have gelled and phase separated;
(b) winding fibers on a liner or on a mandrel;
(c) impregnating the wound fibers of step (b) with the dual chemistry formulation;
(d) activating the first reaction (A) by ultraviolet (UV) light or thermal-free radical initiation sufficient to form first macroscopic gels and to allow the first macroscopic gels to phase separate from the remaining substantially unreacted components in the formulation;
(e) optionally, activating the second reaction by heating through IR lamps or other heating apparatus and controlling the second reaction sufficient to form second macroscopic gels subsequent to the formation of the first macroscopic gels which have gelled and phase separated in the formulation;
(f) repeating steps (a)-(d) until a composite article having a predetermined thickness is formed; and
(g) heating the formed composite article of step (f) sufficient to form a final composite article product having a predetermined glass transition temperature.

2. The process of claim 1, wherein the viscosity of the formulation after step (d) is greater than 10,000 mPa-s.

3. The process of claim 1, wherein the degree of cure for the second reaction components before step (f) is less than 90 percent.

4. The process of claim 1, wherein steps (a)-(d) are repeated at least two times.

5. The process of claim 1, wherein step (d) is carried out by an ultraviolet light curing step and at an ultraviolet wavelength of from about 100 nanometers to about 450 nanometers.

6. The process of claim 1, wherein step (d) is carried out by an ultraviolet light curing step and at an ultraviolet light wavelength of from about 280 nanometers to about 450 nanometers.

7. The process of claim 1, wherein step (g) is carried out at a temperature of from about 100° C. to about 200° C.

8. The process of claim 1, wherein step (g) is carried out at a temperature of from about 120° C. to about 180° C.

9. A cured composite article prepared by the process of claim 1.

10. The composite article of claim 9, wherein the article formed is a cured spoolable pipe member, a pressure vessel, a wind blade, a prepreg, a laminate, a composite, or a coating.
